(19) United States
(12) Patent Application Publication
(10) Pub. No.: US 2011/0314689 A1
(43) Pub. Date: Dec. 29, 2011

(54) SUBSTRATE DRYING METHOD

(76) Inventors: Hisashi OKUCHI, Yokohama-Shi (JP); Yohei SATO, Yokohama-Shi (JP); Hidekazu HAYASHI, Yokohama-Shi (JP); Hiroshi TOMITA, Yokohama-Shi (JP); Yukiko KITAJIMA, Komatsu-Shi (JP)

(21) Appl. No.: 12/980,079

(22) Filed: Dec. 28, 2010

(30) Foreign Application Priority Data
Jun. 23, 2010 (JP) 2010-142301

(51) Int. Cl. F26B 3/02; B08B 3/00

(52) U.S. Cl. 34/357; 134/30; 134/10

(57) ABSTRACT

According to one embodiment, a semiconductor substrate whose surface is wet with a chemical solution (solvent) and formed with patterns having an aspect ratio of 10 or more is loaded into a chamber. Then, while the chemical solution (solvent) remains on the semiconductor substrate, its temperature is increased to a predetermined temperature in the range of 160° C. or more and less than the critical temperature of the chemical solution (solvent), and the evaporated chemical solution (solvent) is discharged from the chamber.

### CROSS REFERENCE TO RELATED APPLICATION

This application is based upon and claims benefit of priority from the Japanese Patent Application No. 2010-142301, filed on Jun. 23, 2010, the entire contents of which are incorporated herein by reference.

### FIELD

Embodiments described herein relate generally to a substrate drying method.

### BACKGROUND

Semiconductor device manufacturing includes various processes such as a lithography process, a dry etching process, and an ion implantation process. Before moving to the next process after the completion of each process, a cleaning process for cleaning a wafer surface by removing impurities and residuals remaining on the wafer surface, a rinsing process for removing chemical solution residuals after cleaning, and a drying process are performed.

For instance, in the wafer cleaning process after the etching process, a chemical solution for the cleaning process is supplied onto the surface of a wafer, and then, pure water is supplied to perform the rinsing process. After the rinsing process, the drying process for drying the wafer by removing the pure water remaining on the surface of the wafer is performed.

As methods for performing the drying process, there have been known methods including, for instance, rotational drying which discharges pure water on a wafer using a centrifugal force by rotation and IPA drying which substitutes isopropyl alcohol (IPA) for pure water on a wafer and evaporates the IPA to dry the wafer. However, in these typical drying processes, there has a problem that fine patterns formed on the wafer are contacted with each other and closed at the time of drying due to the surface tension of the liquid remaining on the wafer.

To solve such problem, supercritical drying in which a surface tension is zero has been proposed. In the supercritical drying, after the wafer cleaning process, a different solvent for which a supercritical drying solvent is finally substituted, e.g., IPA, is once substituted for a liquid on a wafer, and then, the wafer whose surface is wet with the IPA is loaded into a supercritical chamber. Thereafter, for a supercritical state, carbon dioxide (supercritical CO₂ fluid) is supplied into the chamber, the supercritical CO₂ fluid is substituted for the IPA, and the IPA on the wafer is gradually dissolved into the supercritical CO₂ fluid so as to be discharged from the wafer together with the supercritical CO₂ fluid being discharged. After the entire IPA is discharged, the pressure in the chamber is lowered and the supercritical CO₂ fluid is phase changed to vapor CO₂ to complete the drying of the wafer.

However, because the critical pressure of carbon dioxide is approximately 7.5 MPa, a thick metal chamber having a pressure-resistant ability above this critical pressure is necessary as processing equipment. Therefore, There is a problem that the cost of the chamber alone is increased to increase the total apparatus cost.

In addition, there has also been known a method in which the supercritical CO₂ fluid is not used as the drying solvent. In the method, the IPA itself, which is a solution substituted for the rinsing pure water after cleaning the chemical solution, is brought into the supercritical state and is evaporated and discharged for drying. Since the critical pressure of the IPA is approximately 5.4 MPa, as compared with when the supercritical CO₂ fluid is used, the wall thickness necessary for the chamber may be smaller and, accordingly, the apparatus cost can be reduced. In addition, since the IPA itself, which is the solution substituted for the pure water, is brought to be supercritical, unlike carbonic acid supercriticality, a process for substituting the carbon acid supercritical fluid for the IPA is unnecessary. Consequently, a CO₂ supply system necessary for the CO₂ supercriticality and a pressure increasing device are unnecessary so that the cost can be greatly reduced. However, to bring the IPA into the supercritical state, the IPA is required to be superdense by increasing the temperature in the sealed chamber and hence a sufficient amount of the IPA in a liquid state is required to be loaded into the chamber at the beginning of the process. Therefore, there has been a problem that the larger amount of the IPA is used in drying the substrate and, consequently, the cost is increased.

### BRIEF DESCRIPTION OF THE DRAWINGS

FIG. 1 is a state chart showing the relationship among pressure, temperature, and substance phase states;

FIG. 2 is a diagram of assistance in explaining a collapse force applied to patterns at the time of drying a substrate;

FIG. 3 is a schematic block diagram of a substrate processing apparatus according to an embodiment of the present invention;

FIG. 4 is a flowchart of assistance in explaining a cleaning and drying method of a semiconductor substrate according to the embodiment;

FIG. 5 is a state chart of IPA;

FIG. 6 is a diagram showing an example of patterns formed on the semiconductor substrate; and

FIG. 7 is a graph showing the relationship between the temperature at the time of drying a drying solvent and the presence or absence of pattern collapse.

### DETAILED DESCRIPTION

According to one embodiment, a semiconductor substrate whose surface is wet with a chemical solution (solvent) and formed with patterns having an aspect ratio of 10 or more is loaded into a chamber. Then, while the chemical solution (solvent) remains on the semiconductor substrate, its temperature is increased to a predetermined temperature in the range of 160° C. or more and less than the critical temperature of the chemical solution (solvent), and the evaporated chemical solution (solvent) is discharged from the chamber.

Hereafter, an embodiment of the present invention will be described with reference to the drawings.

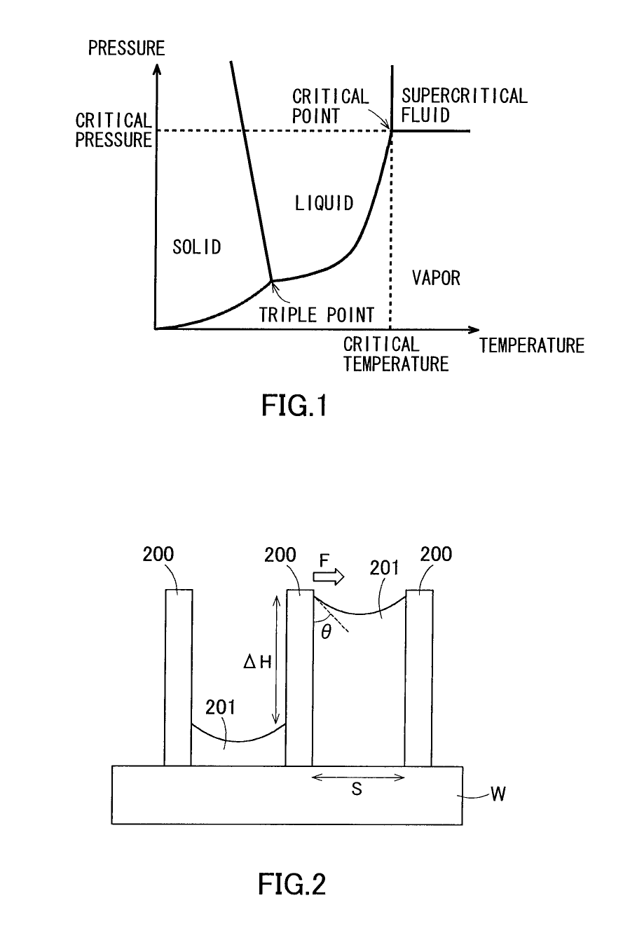

First, a critical point will be described. FIG. 1 is a state chart showing the relationship among pressure, temperature, and substance phase states. In general, a substance has three presence states of a vapor phase (vapor), a liquid phase (liquid), and a solid phase (solid), which are called three phases.

As shown in FIG. 1, the three phases are sectioned by a vapor pressure curve (vapor phase equilibrium line) showing the boundary between the vapor phase and the liquid phase, a sublimation curve showing the boundary between the vapor phase and the solid phase, and a dissolution curve showing the boundary between the solid phase and the liquid phase. The point in which these three phases are overlapped is called a triple point. The vapor pressure curve extends from the triple point to the high-temperature side, and the limit in which the vapor phase and the liquid phase are present together is called a critical point. At the critical point, the densities of the vapor phase and the liquid phase are equal, and the interface of the state in which the vapor phase and the liquid phase are present together disappears. In a high-temperature and high-pressure state above the critical point, the vapor phase and the liquid phase are indistinguishable so that the substance becomes a supercritical fluid.

Next, referring to FIG. 2, a collapse force applied to patterns formed on the substrate at the time of drying a substrate will be described. FIG. 2 shows a state in which each of patterns 200 formed on a semiconductor substrate W is partially wet with a liquid 201. Here, when the distance between the patterns 200 is represented by S, the difference between the liquid surface heights of the liquid 201 on both sides of the patterns 200 is represented by ΔH, the surface tension of the liquid 201 is represented by γ, and the contact angle is represented by θ, a collapse force F applied to each of the patterns 200 is expressed by:

F=2×γ×ΔH×cos θ/S (Equation 1).

Therefore, to reduce the collapse force F to prevent pattern collapse, it is effective that the surface tension γ is reduced, the difference ΔH between the liquid surface heights is reduced, and the contact angle θ is approximated to 90°.

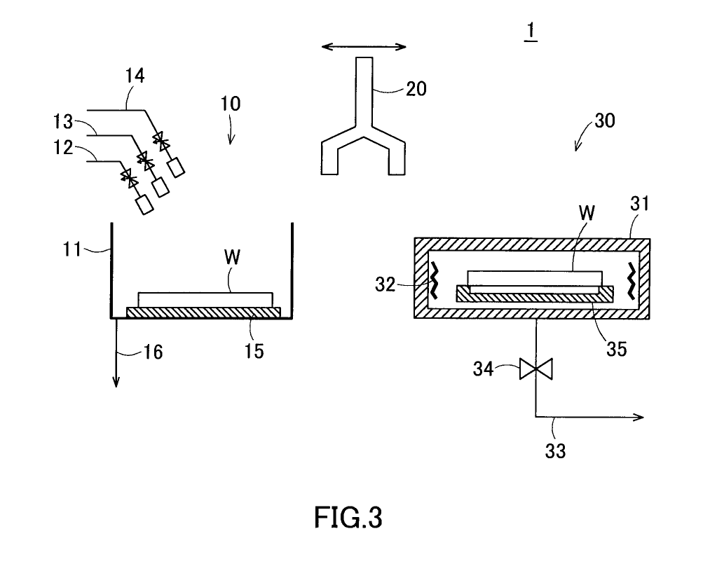

FIG. 3 shows the schematic configuration of a substrate processing apparatus according to an embodiment of the present invention. A substrate processing apparatus 1 has a substrate cleaning portion 10, a substrate conveying portion 20, and a substrate drying portion 30.

The substrate cleaning portion 10 has a cleaning chamber 11, chemical solution supplying portions 12 and 13, and a pure water supplying portion 14. A substrate holding portion 15 which holds the processed substrate (semiconductor substrate) W is provided in the cleaning chamber 11. The substrate cleaning portion 10 may be a single-substrate type cleaning device or a batch type cleaning device.

The chemical solution supplying portion 12 supplies a chemical solution to the processed substrate W to perform the cleaning process of the processed substrate W. As the chemical solution, for instance, sulfuric acid, hydrofluoric acid, hydrochloric acid, hydrogen peroxide, and so on, can be used. The cleaning process includes a process for removing any particles and metal impurities on the surface of the substrate and a process for removing a film formed on the substrate by etching.

The chemical solution supplying portion 13 supplies a drying solvent onto the processed substrate W. As the drying solvent, for instance, isopropyl alcohol (IPA) is used. The pure water supplying portion 14 supplies pure water onto the processed substrate W to perform a pure water rinsing process. The liquid in the cleaning chamber 11 can be discharged via a liquid discharge pipe 16.

The conveying portion 20 takes out the processed substrate W from the cleaning chamber 11 of the substrate cleaning portion 10 to convey the substrate to the substrate drying portion 30.

The substrate drying portion 30 has a drying chamber 31, a heater 32, a pipe 33, and a valve 34. The drying chamber 31 is a high pressure vessel formed of SUS or the like. A stage 35 which holds the processed substrate W and is formed of a ring-like flat plate is provided in the drying chamber 31.

The heater 32 can heat the vapor, the liquid, and the processed substrate W in the drying chamber 31 and adjust the temperature. FIG. 3 shows a configuration in which the heater 32 is provided in the drying chamber 31, but may be provided in the outer circumferential portion of the drying chamber 31.

The pipe 33 is coupled to the drying chamber 31 so that the vapor in the drying chamber 31 can be discharged. The vapor discharged from the pipe 33 is recovered and reproduced by a recovering and reproducing mechanism, which is not illustrated. In addition, the valve 34 which controls an amount of the vapor discharge from the drying chamber 31 is provided on the pipe 33. The valve 34 is a control valve which adjusts the valve opening while monitoring and controlling an internal pressure of the drying chamber 31.

The substrate drying portion 30 may further have a chemical solution supplying portion (not illustrated) which supplies the IPA as the drying solvent into the drying chamber 31.

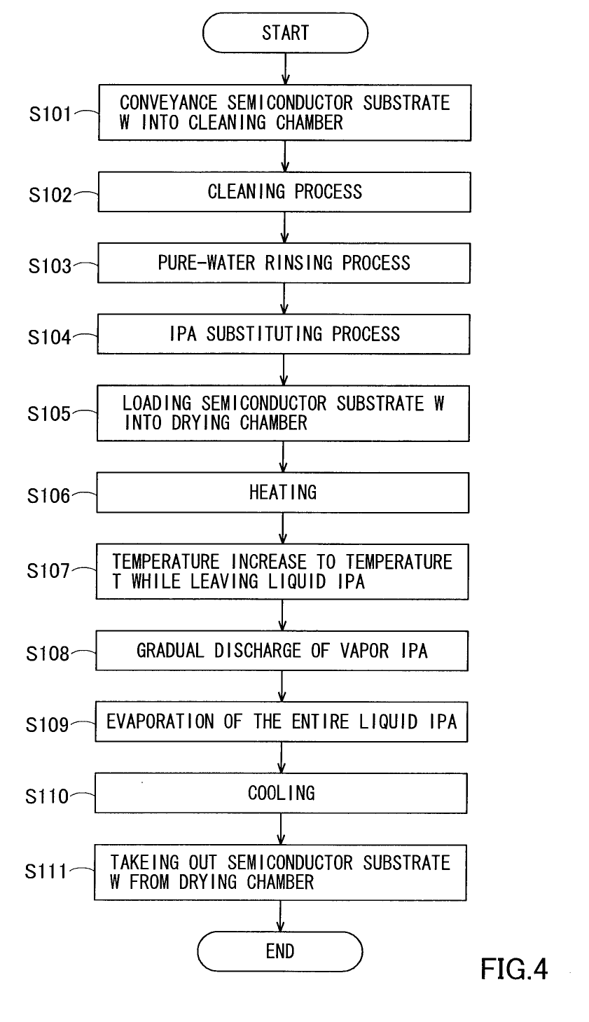

A semiconductor substrate cleaning and drying method according to the present embodiment will be described with reference to the flowchart shown in FIG. 4 and FIG. 3.

(Step S101) The semiconductor substrate W to be processed is conveyed into the cleaning chamber 11 and is held by the substrate holding portion 15. Fine patterns are formed on the semiconductor substrate W.

(Step S102) The chemical solution supplying portion 12 supplies the chemical solution onto the semiconductor substrate W, and thereby, the cleaning process of the semiconductor substrate W is performed.

(Step S103) After the cleaning process, the pure water supplying portion 14 supplies the pure water onto the semiconductor substrate W. Consequently, a pure water rinsing process which washes away the chemical solution remaining on the surface of the semiconductor substrate W by the pure water is performed. The chemical solution is discharged from the liquid discharge pipe 16.

(Step S104) After the pure water rinsing process, the chemical solution supplying portion 13 supplies the IPA as the drying solvent onto the semiconductor substrate W. Consequently, a process for substituting the IPA for the pure water remaining on the surface of the semiconductor substrate W is performed. The pure water is discharged from the liquid discharge pipe 16.

(Step S105) The conveying portion 20 takes out the semiconductor substrate W from the cleaning chamber 11 so as not to air-dry its surface wet with the IPA, conveys it to the substrate drying portion 30, and loads it into the drying chamber 31. The semiconductor substrate W is fixed to the stage 35.

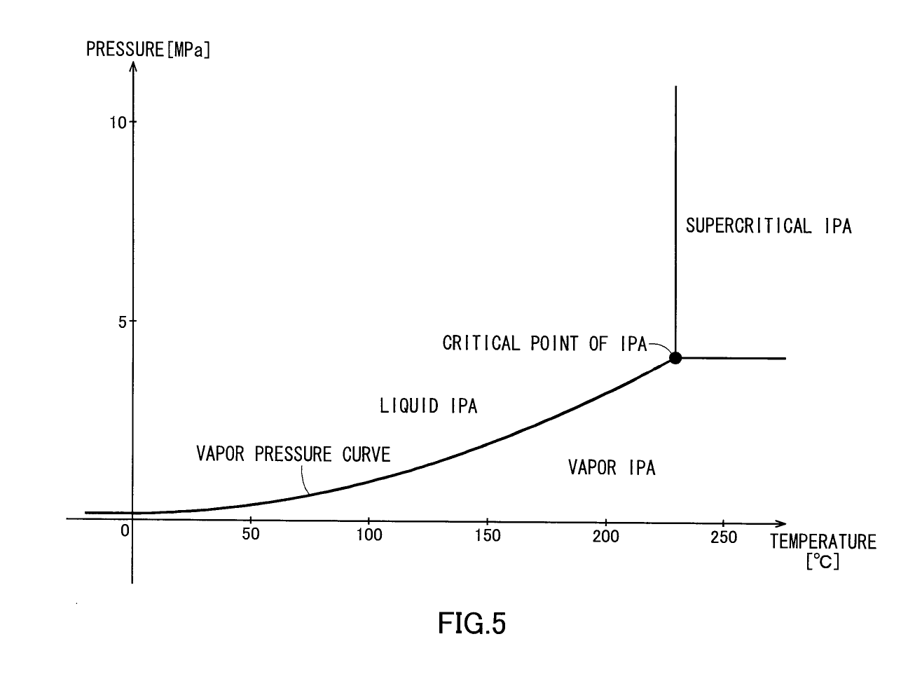

(Step S106) The drying chamber 31 is sealed, and the heater 32 heats the IPA on the surface of the semiconductor substrate W. The IPA in a liquid state is gradually evaporated with heating. At this time, the pressure in the drying chamber 31 is increased according to the vapor pressure curve in the IPA state chart shown in FIG. 5.

(Step S107) The temperature in the drying chamber 31 is increased to a predetermined temperature T. The temperature T is less than the critical temperature (244° C.) of the IPA, and for instance, approximately 180° C. Further, until the temperature T is reached, the IPA on the surface of the semiconductor substrate W should not be dried, that is, the semiconductor substrate W should be wet with the IPA, and the vapor IPA and the liquid IPA should be present together in the drying chamber 31.

The temperature T, a vapor pressure P of the IPA at the temperature T, and a volume V of the drying chamber 31 are substituted into a vapor state equation (PV=nRT; R is a vapor constant) to determine an amount n (mol) of the IPA present in a vapor state in the drying chamber 31. Therefore, the liquid IPA in an amount of the n (mol) or more is required to be present in the drying chamber 31 before heating is started in step S106. When the amount of the IPA on the semiconductor substrate W loaded into the drying chamber 31 is less than the n (mol), the liquid IPA should be supplied from the chemical solution supplying portion, which is not illustrated, into the drying chamber 31 so that the liquid IPA in amount of the n (mol) or more is present in the drying chamber 31.

However, it should be noted that an actual pressure P′ in the drying chamber 31 is the total of partial pressures of all vapor molecules present in the drying chamber 31 and is expressed by the following equation. In the equation, P(IPA) shows the partial pressure of the vapor IPA, P(N₂) shows the partial pressure of nitrogen, and P(O₂) shows the partial pressure of oxygen. In addition, n(IPA) shows the amount (the unit is mol) of the vapor IPA, n(N₂) shows the amount of nitrogen, and n(O₂) shows the amount of oxygen.

$$\begin{matrix}{P}^{′} = P ( IPA ) + P ( {N}_{2} ) + P ( {O}_{2} ) + … \\ = ( n ( IPA ) + n ( {N}_{2} ) + n ( {O}_{2} ) + … ) RT / V\end{matrix}$$

In the following description, suppose that only the IPA is ideally present in the drying chamber 31.

(Step S108) While the temperature T in the drying chamber 31 is maintained, the valve 34 is opened, and the vapor IPA in the drying chamber 31 is gradually discharged via the pipe 33. At this time, because the liquid IPA remaining on the semiconductor substrate W can be bumped when the pressure in the drying chamber 31 is abruptly lowered, the opening of the valve 34 must be adjusted so as not to bump the liquid IPA. Because the interior of the drying chamber 31 is in a vapor pressure equilibrium state, the evaporation of the liquid IPA is advanced by the amount of the discharged vapor. IPA. Therefore, at the same temperature and under the same pressure, the amount of the vapor phase IPA in the drying chamber 31 is the n (mol) at all times.

In addition, the heat of evaporation of the IPA in the drying chamber 31 is required to be supplied by the heater 32. Of the liquid IPA remaining in the drying chamber 31, the amount of heat for evaporating the liquid IPA equal in amount to that of the vapor phase IPA discharged from the drying chamber 31 is needed. Therefore, the supplied heat (J) to be supplied by the heater 32 is obtained by: the heat of evaporation of the IPA (J/mol)×the vapor IPA amount (mol) discharged from the drying chamber 31. While the liquid IPA remains on the semiconductor substrate W, when the pressure and the temperature in the drying chamber 31 are constant, the vapor IPA concentration in the drying chamber 31 is held constant.

(Step S109) After the entire liquid IPA in the drying chamber 31 is evaporated and the semiconductor substrate W is dried, the opening of the valve 34 is increased to discharge the vapor IPA in the drying chamber 31. Because the entire liquid IPA is evaporated and there is no fear of bumping, the discharging amount of the vapor IPA is increased so that the processing time can be shortened. The temperature is maintained sufficiently high so as not to cause reliquefaction of the IPA due to the lowered pressure in the drying chamber 31 with the discharge of the vapor IPA. For instance, the temperature in the drying chamber 31 is maintained at the temperature T.

Further, the vapor IPA discharged from the drying chamber 31 via the pipe 33 is recovered, reproduced, and reused by a recovery and reproduction mechanism, which is not illustrated.

(Step S110) After the vapor IPA in the drying chamber 31 is sufficiently discharged, the semiconductor substrate W is cooled to the conveyable temperature.

(Step S111) The drying chamber 31 is opened to convey the semiconductor substrate W to the next process.

In this way, in the present embodiment, the temperature and the pressure are increased so as not to evaporate the entire liquid IPA on the semiconductor substrate W, thereby drying the semiconductor substrate W in the predetermined high-temperature and high-pressure state. The surface tension of the liquid is lowered by increasing the temperature. Therefore, as seen from the above Equation 1, when the liquid IPA is evaporated in step S108, the collapse force F applied to the fine patterns on the semiconductor substrate W is reduced, and consequently, pattern collapse can be prevented.

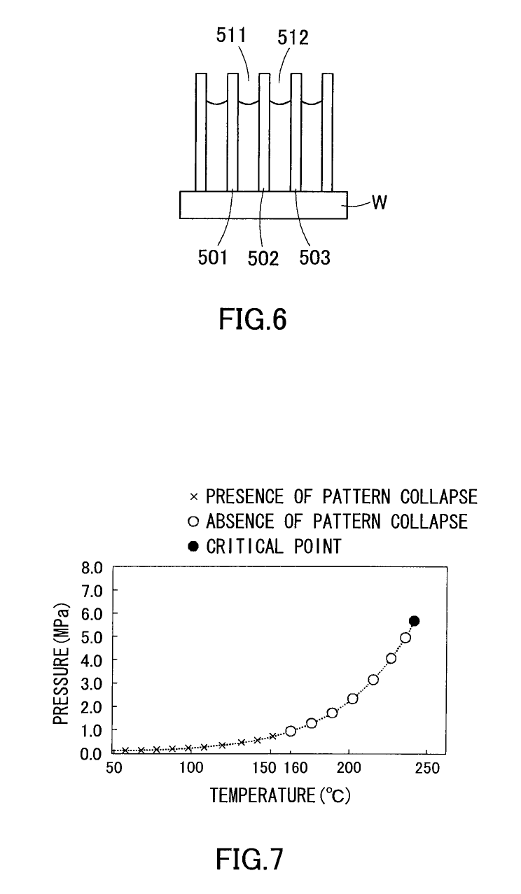

In addition, due to the high-pressure state, as shown in FIG. 6, the liquid in a trench 511 interposed between a pattern 501 and a pattern 502 as well as the liquid in a trench 512 interposed between the pattern 502 and a pattern 503 form liquid surfaces substantially perpendicular to the patterns to minimize their own surface areas exposed to a space, and in appearance, the contact angle of the patterns and the liquids is changed to the liquid repellency side. In other words, because the θ in the above Equation 1 is approximated to 90°, the cos θ is approximated to zero. For this reason, the collapse force F applied to the fine patterns on the semiconductor substrate W can be smaller.

FIG. 7 shows the relationship between the temperature T for evaporating the entire IPA on the semiconductor substrate W and the presence or absence of pattern collapse on the semiconductor substrate W. Patterns including an oxide film, a nitrogen film, silicone or the like and having an aspect ratio of approximately 10 are formed on the semiconductor substrate W.

As seen from this result, when the semiconductor substrate formed with the patterns having an aspect ratio of 10 or more is dried, the temperature of the drying solvent is preferably at 160° C. or more (a pressure of 1 MPa or more). Therefore, the predetermined temperature T in step S107 is preferably in the range of 160° C. or more and less than the critical temperature.

In the present embodiment, since the drying process is performed at the pressure and temperature less than the critical point (244° C. and 5.4 MPa) of the IPA, as compared with the chamber performing supercritical drying, the cost of the drying chamber 31 can be reduced. In addition, since the drying process is performed at the pressure and temperature less than the critical point, as compared with a case where the IPA is brought into the supercritical state, the amount of the used IPA can be reduced. Further, in the drying method according to the present embodiment, when the drying solvent is recycled and used, as compared with the method for bringing the IPA into the supercritical state, the decomposition rate of the IPA itself is lower and the solvent recovery rate is higher. Therefore, the amount of the used drying solvent can be further reduced, and the cost can be reduced.

In this way, in the substrate drying method according to the present embodiment, the semiconductor substrate formed with the fine patterns can be dried at low cost while preventing pattern collapse.

In the above embodiment, in step S110, the semiconductor substrate W is cooled in the drying chamber 31. However, a different stage for cooling may be provided to convey the semiconductor substrate W to the different stage immediately after the completion of the discharge of the vapor IPA in the drying chamber 31. With such an arrangement, because the drying chamber 31 is not required to be cooled and the next substrate process can be immediately started, the throughput can be increased.

In the above embodiment, the IPA is used as the drying solvent, but a different chemical solution, such as methanol and ethanol, which can be substituted for water may be used. When the different chemical solution is used, as in the above embodiment, the chemical solution in a liquid amount to the extent that the chemical solution is present is previously loaded into the drying chamber until it is brought into the predetermined high-temperature and high-pressure state, in which pattern collapse is not caused. When it reaches the predetermined high-temperature and high-pressure state less than the critical point, the evaporated chemical solution is gradually discharged to evaporate the entire chemical solution on the substrate, thereby drying the substrate. Further, when methanol is used as the drying solvent, the temperature is preferably increased to in the range of 100° C. or more and less than the critical temperature (240° C.), and when ethanol is used, the temperature is preferably increased to in the range of 100° C. or more and less than the critical temperature (243° C.).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A substrate drying method comprising:
loading a semiconductor substrate, whose surface is wet with a chemical solution and formed with patterns having an aspect ratio of 10 or more, into a chamber;
leaving the chemical solution on the semiconductor substrate and increasing the temperature to a predetermined temperature in a range of 160° C. or more and less than a critical temperature of the chemical solution; and
discharging an evaporated chemical solution from the chamber.

2. The substrate drying method according to claim 1, further comprising:
cleaning the semiconductor substrate by using a second chemical solution;
after cleaning the semiconductor substrate, rinsing the semiconductor substrate by using pure water; and
supplying the chemical solution onto the semiconductor substrate, after rinsing the semiconductor substrate by using pure water and before loading the semiconductor substrate into the chamber.

3. The substrate drying method according to claim 2, wherein before increasing the temperature, the chemical solution in a liquid amount based on the predetermined temperature, vapor pressure of the chemical solution at the predetermined temperature, and the volume of the chamber is supplied into the chamber.

4. The substrate drying method according to claim 2, wherein when the evaporated chemical solution is discharged from the chamber, the temperature in the chamber is maintained at the predetermined temperature.

5. The substrate drying method according to claim 3, wherein when the evaporated chemical solution is discharged from the chamber, the temperature in the chamber is maintained at the predetermined temperature.

6. The substrate drying method according to claim 2, wherein with the evaporation of the entire chemical solution in the chamber, discharge amount of the evaporated chemical solution discharged from the chamber is increased.

7. The substrate drying method according to claim 2, wherein amount of heat based on the discharge amount of the evaporated chemical solution discharged from the chamber and heat of evaporation of the chemical solution is supplied into the chamber.

8. The substrate drying method according to claim 2, wherein the temperature of the chemical solution is increased to the predetermined temperature so that pressure in the chamber is 1 MPa or more.

9. The substrate drying method according to claim 3, wherein the temperature of the chemical solution is increased to the predetermined temperature so that pressure in the chamber is 1 MPa or more.

10. The substrate drying method according to claim 4, wherein the temperature of the chemical solution is increased to the predetermined temperature so that pressure in the chamber is 1 MPa or more.

11. The substrate drying method according to claim 2, wherein the chemical solution is isopropyl alcohol.

12. The substrate drying method according to claim 2, wherein the chemical solution in a vapor state discharged from the chamber is recovered and is reproduced.
